(19) United States
(12) Patent Application Publication
(10) Pub. No.: US 2011/0267848 A1
(43) Pub. Date: Nov. 3, 2011

(54) POWER CONVERTER

(75) Inventors: Yuki SATAKE, Tokyo (JP); Shigeki Teratani, Tokyo (JP)

(73) Assignee: SHINTO HOLDINGS CO., LTD., Tokyo (JP)

(21) Appl. No.: 13/077,652

(22) Filed: Mar. 31, 2011

(30) Foreign Application Priority Data
Apr. 28, 2010 (JP) 2010-103815

(51) Int. Cl. H02M 3/335

(52) U.S. Cl. 363/21.12

(57) ABSTRACT

Reduction of power loss and operation in a two-phase mode are made possible.

The power converter of present invention is a power converter composed of a core formed by a magnetic material and a winding wire wound at a predetermined position of the core and operating in a two-phase mode, in which the core is a closed magnetic path constituted by a center leg, a cylindrical first outer leg arranged in parallel with the center leg and around which the winding wire is wound, and a second outer leg arranged at a position opposite to the first outer leg with respect to the center leg.

### CROSS-REFERENCE TO RELATED APPLICATION

This application claims priority to Japanese Patent Application No. 2010-103815 filed on Apr. 28, 2010 and all the benefits accruing therefrom under 35 U.S.C. §119, the contents of which are incorporated by reference in their entirety.

### BACKGROUND

1. Technical Field

The present invention relates to a power converter that operates in a two-phase mode and particularly to a power converter having a characteristic in a core shape formed by a magnetic material.

2. Description of the Related Art

Hitherto, in electronic equipment products such as audio-visual devices, OA information devices and the like, power factor improvement circuits that improve a power factor are known.

An example of this power factor improvement circuit includes a circuit in which a plurality of booster circuits are connected in parallel with a DC current and each booster circuit is composed of a booster chalk, a booster diode, and a switching element. For example, a method in which a smoothing capacitor is connected to an output side of the booster circuit, a load is connected in parallel with the smoothing capacitor, and each switching element that constitutes the booster circuit is subjected to pulse-width modulation control by a control signal pulse supplied from a control circuit is proposed in Patent Document 1.

### CITATION LIST

### Patent Literature

PTL 1: Japanese Unexamined Patent Application Publication No. 2002-10632

### SUMMARY OF INVENTION

### Technical Problem

In the above-described DC/DC converter, each booster circuit is composed of an inductor portion, a booster diode, and a switching element. The switching element executes on/off control with a phase difference of 180 degrees by using two booster circuits, and this DC/DC converter operates in a two-phase mode. In this type of DC/DC converter, if a core formed by a magnetic material has a square shape, there has been a problem that when a winding wire is wound, a bonding degree between the core and the winding wire is poor, and power loss is large.

On the other hand, in the industrial fields, for devices using a power converter (such as a DC/DC converter, an inverter circuit and the like, for example) such as in a hybrid vehicle (and robots, home electric appliances and the like), size reduction of a power converter to be mounted on them is in a great demand. There is a problem that the request of size reduction cannot be met in the above-described chopper-type DC/DC converter.

Thus, development of a power converter that is compact and operates in a two-phase mode is an imminent problem in the devices using a power converter such as hybrid vehicles (and robots, home electric appliances and the like).

### SUMMARY

Thus, the present invention was made in view of the above circumstances and has an object to provide a power converter operating in a two-phase mode and having a characteristic in a core shape, whose occupied area is small, size can be reduced and power loss can be decreased.

### Solution to Problem

A power converter of the present invention is a power converter which is composed of a core formed by a magnetic material and a winding wire wound around a predetermined position of the core and operates in a two-phase mode, in which the core is a closed magnetic path constituted by a center leg, a first outer leg which has a cylindrical shape and is arranged in parallel with the center leg and around which a winding wire is wound, and a second outer leg which is arranged at a position opposite to the first outer leg with respect to the center leg.

The center leg of the power converter of the present invention may be a cylindrical shape.

The “cylindrical shape” refers not only to a columnar shape but also includes an elliptical cylindrical shape.

The core of the power converter of the present invention may be capable of separation.

The power converter of the present invention is to boost an output voltage of a DC power supply and may be composed of two transducers whose respective primary windings are connected to a positive electrode of a positive power supply of the DC power supply, two switching elements connected between the respective primary windings of the transducers and a negative electrode of the DC power supply, an inductor portion connected between secondary winding of the first transducer and the secondary winding of the second transducer, and two serial circuits connected between the respective primary windings of the two transducers and the negative electrode of the DC power supply and including a diode and a capacitor, respectively, in which the secondary windings of the two transducers and the inductor portion are connected in series to each other so as to form a closed loop, the capacitors included in the two serial circuits share a single smoothing capacitor, and the core is composed by two outer legs around which the primary windings of the two transducers are wound and the center leg.

The shape of the entire core of the power converter of the present invention may be rounded.

The winding of the power converter of the present invention may have the same number of windings as each other.

The power converter of the present invention may be a DC/DC converter.

Also, the power converter of the present invention may be an inverter circuit device. Moreover, the power converter of the present invention may be a converter to be mounted on any one of an electric vehicle, a robot, a home electric appliance, a solar generator, a motor electric generator, a large-capacity power supply, medical equipment, a liquid-crystal TV, and an LED illumination power source.

### Advantageous Effects of Invention

According to the power converter of the present invention, since the core is a closed magnetic path composed of the center leg, the first outer leg having a cylindrical shape and arranged in parallel with the center leg around which a winding wire is wound, and a second outer leg arranged at a position opposite to the first outer leg with respect to the center leg, when a winding wire is to be wound, a bonding degree between the core and the winding wire can be increased, power loss can be decreased, and the size can be reduced.

### BRIEF DESCRIPTION OF DRAWINGS

FIG. 1 is a circuit diagram illustrating an example of a DC/DC converter in an embodiment of the present invention.

FIG. 2 is a circuit diagram illustrating an example of a DC/DC converter having a magnetic circuit in the embodiment of the present invention.

FIG. 3 is a diagram illustrating an example of a core shape in the embodiment of the present invention.

FIG. 4 is a diagram illustrating an example in which the core shape in FIG. 3 is replaced by a magnetic circuit.

FIGS. 5A-5C are diagrams illustrating an example of a core in the embodiment of the present invention, in which an outer leg portion of the core has a cylindrical shape.

FIGS. 6A-6C are diagrams illustrating an example of a bobbin that holds the core in FIG. 5.

FIGS. 7A-7B are diagrams illustrating a square-shaped magnetic body and a state in which a winding wire is wound around a cylindrical magnetic body.

FIG. 8 is a diagram illustrating a combination of the core shown in FIG. 5 and the bobbin shown in FIG. 6.

FIGS. 9A-9C is a diagram illustrating an example of a core having a rounded shape in the embodiment of the present invention.

FIG. 10 is a sectional view illustrating a combination of the two cores having the rounded shape in the embodiment of the present invention.

FIG. 11 are diagrams illustrating comparison in magnetic flux density distribution between a square-shaped core and a rounded-shaped core.

### DETAILED DESCRIPTION

A power converter as an embodiment of the present invention will be described by referring to the attached drawings.

The power converter of the present invention is composed of a core formed by a magnetic material and a winding wire wound at a predetermined position of the core and operates in a two-phase mode, in which the core is a closed magnetic path composed of a center leg, a first outer leg having a cylindrical shape (not only a columnar shape but may include an elliptical cylindrical shape) and arranged in parallel with the center leg and around which a winding wire is wound, and a second outer leg arranged at a position opposite to the first outer leg with respect to the center leg.

The power converter of the present invention may be an IC circuit by interleave control.

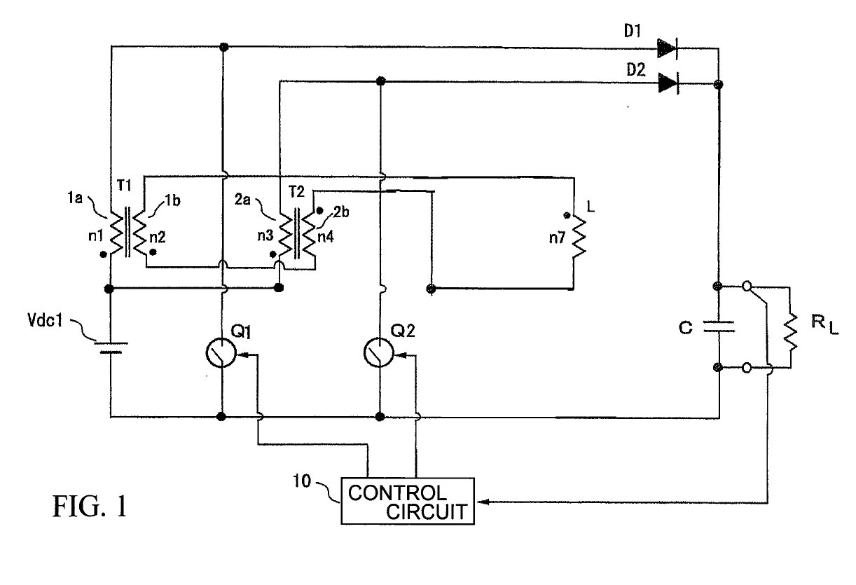

First, a booster-type DC/DC converter, which is an example of the power converter of the present invention, will be described. FIG. 1 shows this DC/DC converter.

In this embodiment, the DC/DC converter that performs a boosting operation in the two-phase mode will be described. The insulation-type DC/DC converter of this example has two transducers T1 and T2 and combines converter outputs by each transducer. Then, by doubling the frequency and by adding it to an inductor portion, size reduction of the inductor portion that functions as an energy storage element is realized.

Also, the cores can be integrated into one by bonding the inductor portions, which are the energy storage elements, by the transducer and moreover, an inductor current component in each phase can be superimposed in the energy storage element, whereby a ripple width is reduced, and size reduction of the core itself can be realized.

An output voltage of a DC power supply Vdc1 is boosted to a predetermined voltage. To a positive electrode of the DC power supply Vdc1, one ends (winding start ends) of primary windings of the two transducers T1 and T2 are connected, respectively. The first and second transducers T1 and T2 have the same configurations. The first transducer T1 has primary winding 1a and secondary winding 1b, and a first switching element Q1 is connected between the other end of the primary winding 1a and a negative electrode of the DC power supply Vdc1. As the switching element, various switching elements such as MOSFET can be used. The second transducer T2 has primary winding 2a and secondary winging 2b, and a second switching element Q2 is connected between the other end of the primary winding 2a and the negative electrode of the DC power supply. The switching elements Q1 and Q2 are sequentially on/off controlled by a control circuit 10 with a phase difference of ½ cycle.

In this embodiment, between the secondary winding 1b of the first transducer T1 and the secondary winding 2b of the second transducer T2, an inductor portion L is connected. The secondary winding 1b and 2b of the first and second transducers T1 and T2 and the inductor portion L are connected in series so as to form a closed loop.

Between the primary winding 1a of the first transducer T1 and the negative electrode of the DC power supply Vdc1, a serial circuit of a diode D1 and a smoothing capacitor C is connected. Between the primary winding 2a of the second transducer T2 and the negative electrode of the DC power supply, a serial circuit of a diode D2 and the smoothing capacitor C is connected. A load RL is connected in parallel with the smoothing capacitor C.

The first transducer T1, the first diode D1, and the smoothing capacitor C constitute a first converter. The second transducer T2, the second diode D2, and the smoothing capacitor C constitute a second converter.

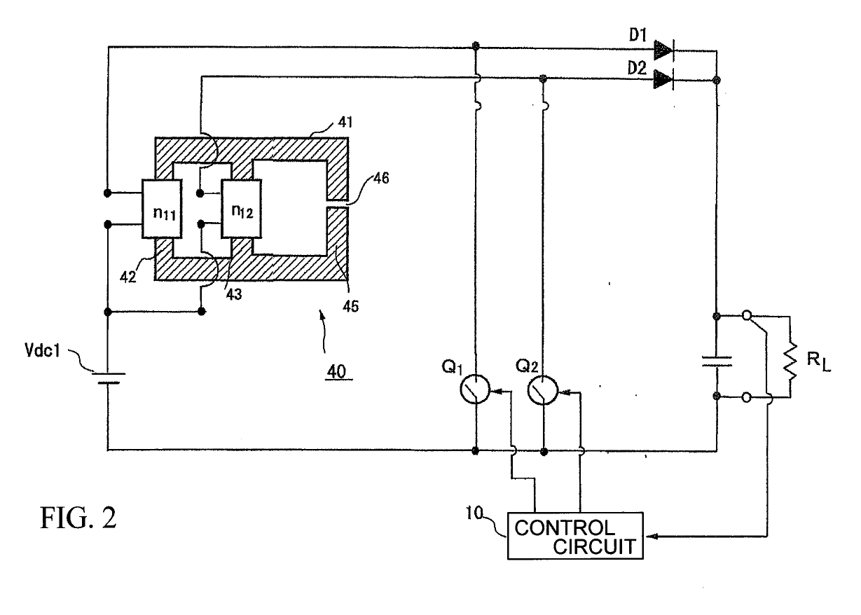

FIG. 2 is a diagram illustrating an example of the DC/DC converter according to the present invention, having a magnetic circuit. The same reference numerals are given to the same constituent elements as those used in FIG. 1 in the following description. A DC voltage of the DC power supply Vdc1 is boosted. The magnetic circuit 40 is constituted by a single core 41 forming a closed magnetic path. The core 41 has first to third legs 42, 43, and 45, in which a first winding wire n11 is wound around the first leg 42 (outer leg), and a second winding wire n12 is wound around the second leg 43 (outer leg). In the third leg 45 (center leg), an air gap 46 is formed.

Also, an arrangement position of the third leg in which the air gap is formed can be disposed between the first leg and the second leg. The air gap does not have to be formed.

Each one end of the first to second winding wires n11 to n12 is connected to the positive electrode of the DC power supply Vdc1, and each of the other ends is connected to the negative electrode of the DC power supply via the switching elements Q1 and Q2, respectively. Between the other end of the first winding wire n11 and the negative electrode of the DC power supply, the first serial circuit including the diode D1 and the smoothing capacitor C is connected. Between the other end of the second winding wire n12 and the negative electrode of the DC power supply, the second serial circuit including the second diode D2 and the smoothing capacitor C is connected. The load RL is connected in parallel with the smoothing capacitor C.

The first winding wire n11, the first diode D1, and the smoothing capacitor C constitute a first converter. The second winding wire n12, the second diode D2, and the smoothing capacitor C constitute a second converter.

The first and second switching elements Q1 and Q2 are sequentially operated by a driving pulse sequentially supplied from the control circuit 10.

Since this two-phase mode DC/DC converter uses a complex magnetic circuit constituted by a single core having three legs instead of two transducers and one inductor portion, a further small-sized DC/DC converter is realized.

In the above-described two-phase mode DC/DC converter, the inductor portion, which is an energy storage element, is bonded by the transducer so that the core can be integrated into one and moreover, an inductor current component in each phase can be superimposed in the energy storage element, whereby a ripple width is reduced, and size reduction of the core itself can be realized. Also, a capacity of an electrolytic capacitor can be decreased.

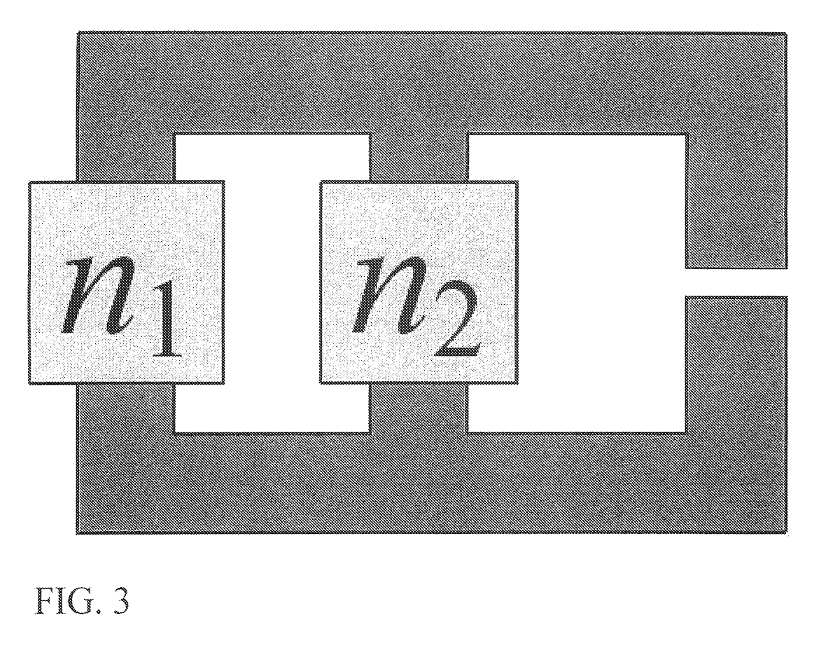

FIG. 3 illustrates the above-described magnetic circuit 40 in FIG. 2 in a simplified form of a core shape to be easily understood (in simplification, the first winding wire n11 is referred to as n1 and the second winding wire n12 as n2).

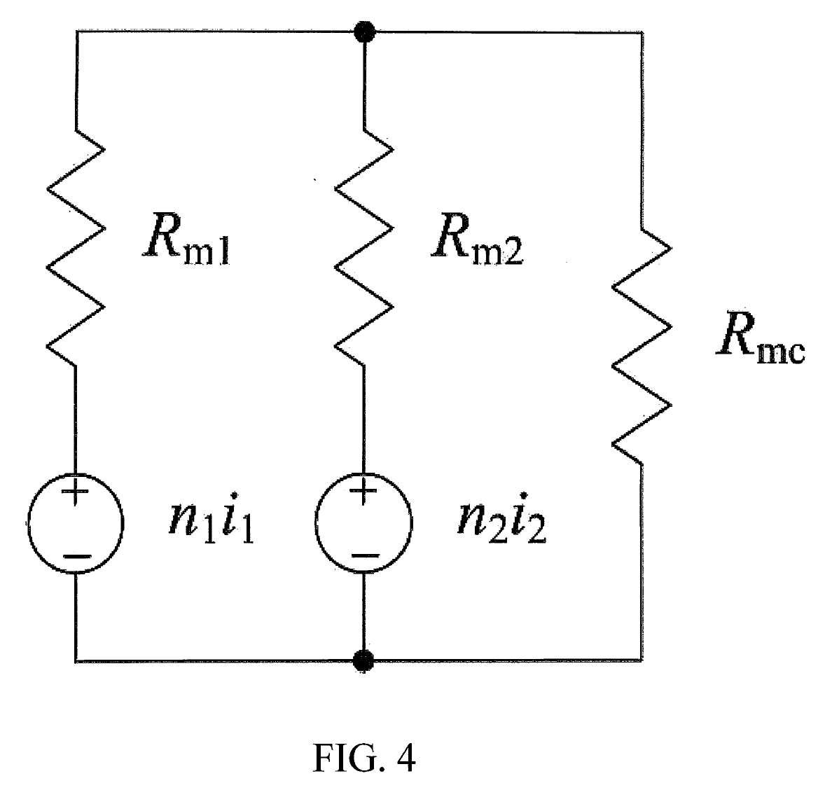

FIG. 4 shows a state in which the core shape in FIG. 2 is replaced by the magnetic circuit.

As shown in FIG. 4, a magnetic path length is fluctuated with respect to the magnetic flux generated in the winding in each phase with this shape, this fluctuation affects a current balance in each phase and concentrates the current to only one phase, and thus, multi-phase does not make sense and an increase in loss caused by magnetic saturation and the like is also worried.

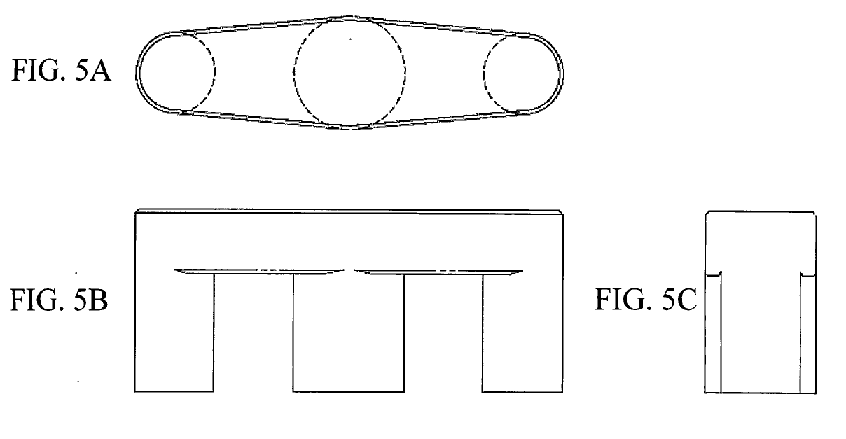

The power converter of the present invention is made in a core shape that can solve this imbalance, and the core shape as in FIG. 5 is shown as an example. Two pieces of the core shown in FIG. 5 are prepared, and a core is formed by abutting the bottom faces of the outer legs of the respective cores. Since the two cores are used, the cores can be separated from each other.

FIG. 5A shows a bottom view of the core, FIG. 5B shows a front view of the core (the rear view is omitted, since it is the same as the front view), and FIG. 5C shows a left side view of the core (the right side view is omitted since it is the same as the left side view).

As is known from the core shown in FIG. 5, it is obvious that the magnetic path lengths seen from all the windings match in all the phases. Also, in the core shown in FIG. 5, the two outer legs (the first outer leg and the second outer leg) located at both ends of this core and the center leg located at the center of the core have cylindrical shapes.

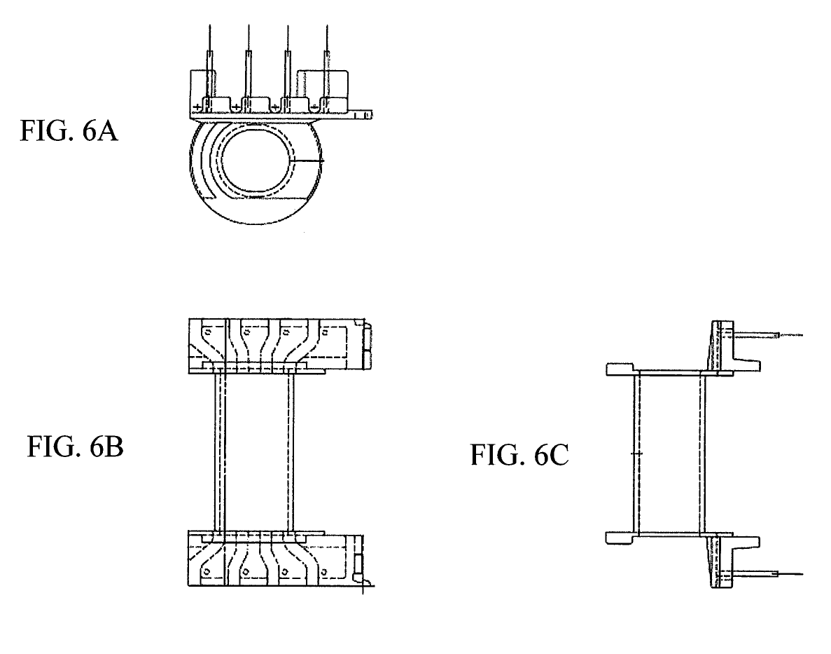

FIG. 6 show a bobbin that holds the core in FIG. 5, and by holding this core by the bobbin, the magnetic circuit is formed. FIG. 6A shows a left side view of the bobbin (the right side view is omitted since it is the same as the left side view), FIG. 6B shows a bottom view of the bobbin, FIG. 6C shows a front view of the bobbin (the rear view is omitted since it is the same as the front view).

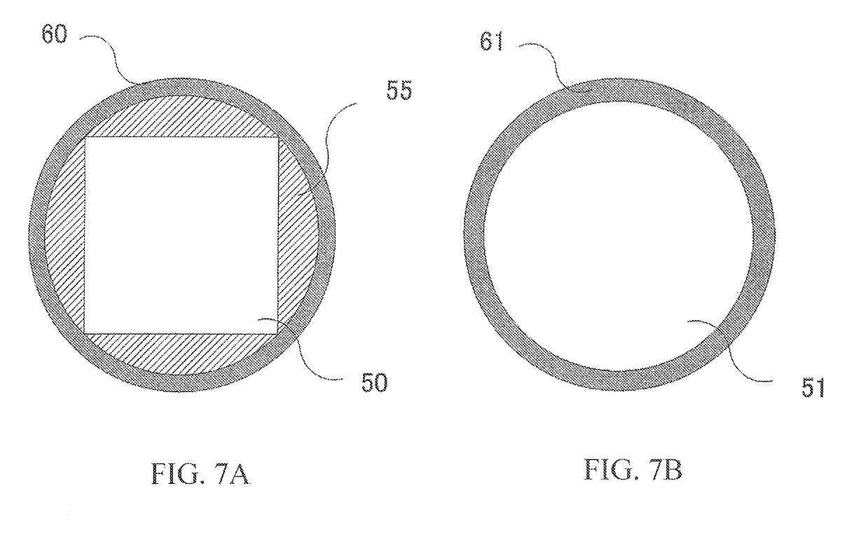

As shown in FIG. 5, by forming the outer legs of the core in the cylindrical shapes, the bonding degree in winding of the winding wire is improved. Specific description will be made by referring to FIG. 7.

FIG. 7A is a schematic diagram illustrating a section if the core (magnetic body 50) around which the winding wire is wound has a prism shape, and FIG. 7B is a schematic diagram illustrating a section if the core (magnetic body 51) around which the winding wire is wound has a cylindrical shape.

In the case of FIG. 7A, a space 55 is generated between a winding wire 60 and the magnetic body 50, but in the case of FIG. 7B, a space is hardly generated between a winding wire 61 and the magnetic body 51. Thus, if the shape of the core (magnetic body) is cylindrical, bonding degree of the winding becomes stronger, and power loss is decreased.

Also, the entire shape of the core may be rounded (hereinafter referred to as a rounded shape).

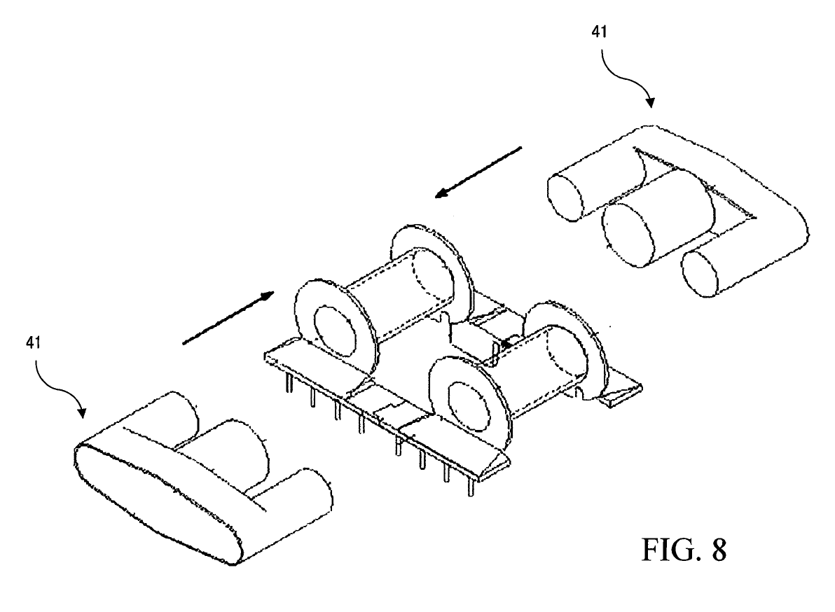

Also, FIG. 8 shows a state in which the core shown in FIG. 5 is combined with the bobbin shown in FIG. 6. By combining the core and the bobbin as shown in FIG. 8 and by winding the winding wire on the cylinder of the bobbin to be combined with the outer legs of the core, a magnetic circuit is formed.

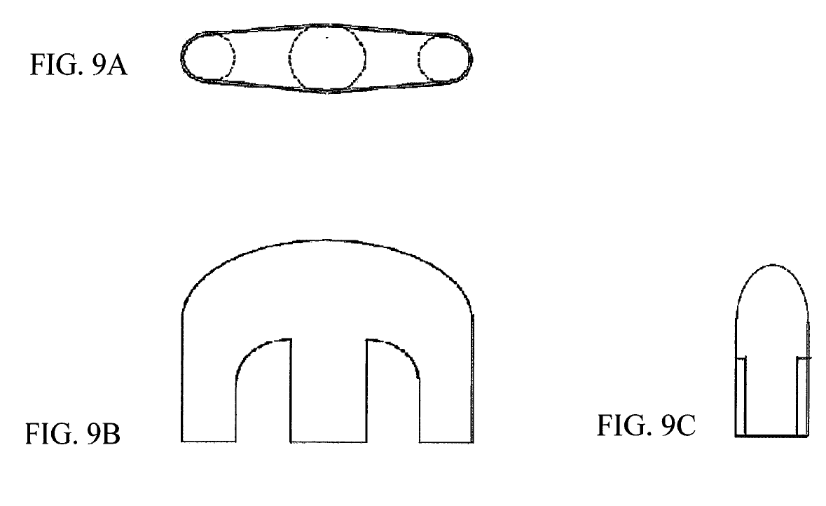

Also, the embodiment of the present invention may be formed such that the entire shape of the core is rounded as shown in FIG. 9. FIG. 9A shows a bottom view of the rounded core, FIG. 9B shows a front view of the rounded core (rear view is omitted since it is the same as the front view), and FIG. 9C shows a left side view of the rounded core (right side view is omitted since it is the same as the left side view).

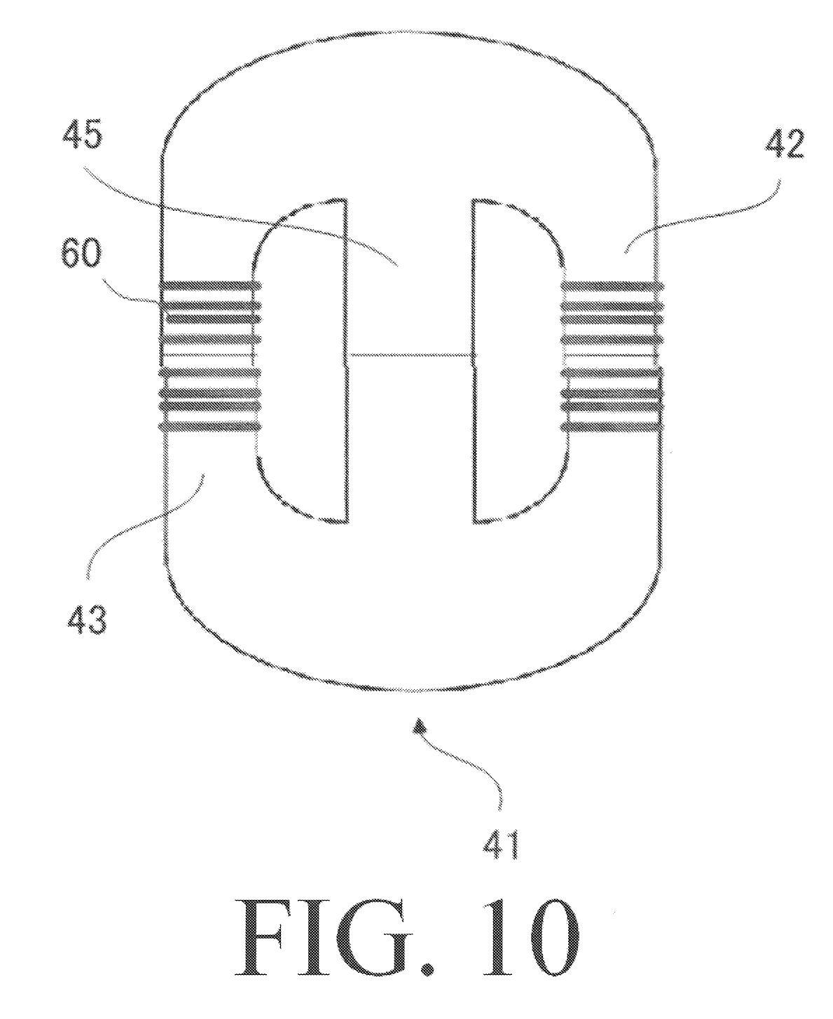

For example, FIG. 10 is a sectional view of a combination of the two cores, each having a rounded entire shape. The two cores as in FIG. 10 can be separated from each other.

Also, as described above, if the bobbin as shown in FIG. 6 is attached onto the outer legs 42 and 43 in FIG. 10, the winding wire is wound on the cylinder of the bobbin. Also, in the embodiment of the present invention, the winding wire may be wound around the outer legs 42 and 43 without the need of preparing the bobbin.

Specifically, as for the core material in the embodiment of the present invention, in the case of a core material with high magnetic permeability (μ) such as a ferrite material, for example, a bobbin may be used so as to wind the winding wire around the bobbin.

On the other hand, in the case of a core material with low magnetic permeability (μ) such as a dust material, for example, the winding wire may be wound directly around the core without using the bobbin.

In order to demonstrate utility of the power converter with a core having an entire rounded shape, computer simulation was conducted for the core shape considering magnetic flux leakage. First, the simulation method will be described and then, the result will be described.

As a simulation method, first, in order to verify a leakage flux generated from a passive element member installed on a printed circuit board in advance, a core shape of the passive element member is inputted, three-dimensional modeling is created from the inputted core shape of the passive element member, a region in the three-dimensional modeling is divided, analysis sample data is registered for each divided region, a finite element method is performed on the basis of the data of the three-dimensional modeling for which the analysis sample data is registered, and calculation for verifying the leakage flux is made.

Specifically, the passive element members are members provided with a transducer, an inductor portion and the like.

Also, the input of the shape means an input of at least a shape of the core of the passive element member or the like, and it may be an input of a core shape different from the columnar core. Also, it may be an input of a core shape, which is a rounded shape.

In generating three-dimensional modeling, the inputted shape of the core of the passive element member or the like is illustrated in a three-dimensional manner on a computer. For example, a surface may be created.

The analysis sample data refers to data relating to components constituting the core of the passive element member or the like, the air present around the core and the like. For example, it may be data relating to magnetic permeability of the core of the passive element member and/or current density of the core.

The calculation is made by executing the finite element method in order to verify the leakage flux generated from the core of the passive element member installed on the printed circuit board or the like using a computer.

Indication refers to indication of a verification result of the leakage flux or the like.

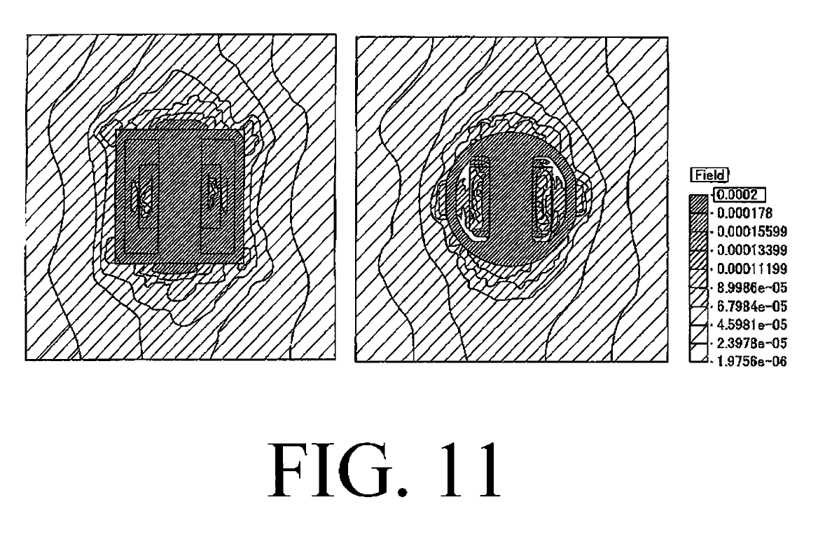

Here, the result of use of this simulation method is shown in FIG. 11. First, a result of the execution of the simulation as above and an analysis result expressed by absolute values of magnetic flux density vectors, that is, intensities of the magnetic flux density by shading of color are indicated.

By applying the magnetic flux analyzing simulator using the finite element method as above, degrees of the magnetic flux leakage of a prior-art square shape and a new rounded shape of cores having the same capacity are indicated. In the square core shape as shown in FIG. 11, the magnetic flux leakage at four corner parts is confirmed, but it can be also confirmed that very little magnetic flux is leaking as a whole in the rounded-shaped core.

As described above, the power converter in the embodiment of the present invention may have a square core shape as those having been used hitherto, but with this shape, a large amount of magnetic flux leakage is anticipated.

Thus, for the power converter of the present invention, a rounded core shape may be employed in which the square core is formed in a gently drawn loop so that the effect of reducing the magnetic flux leakage from the corner parts of the core can be obtained.

The section of the new core shape in which the argument of the magnetic path length and the argument of the core shape considering the leakage flux are combined as above is shown in FIG. 10. In the case of this shape, the magnetic path lengths to the winding wire in each phase become the same, and it is expected that the magnetic flux leakage can be minimized.

As the rounded core shape shown in FIG. 10, only the core is shown in order to facilitate understanding of the core shape, but when it is used as the power converter of the present invention, the winding wire is wound around the core in FIG. 10, and an electric current is made to flow through it for use.

As described above, the power converter of the present invention is a power converter composed of a core formed by a magnetic material and a winding wire wound around a predetermined position of the core and operating in a two-phase mode, in which the core forms a closed magnetic path provided with the center leg (the air gap may be formed or does not have to be formed) and two outer legs around which the winding wires are wound and in parallel with the center leg and having lengths longer than (or the same as) the length of the center leg, and the center leg and the two outer legs in the core have cylindrical shapes.

Also, the cores shown in FIG. 8 and FIG. 10 can be separated into two parts. Also, the cores may be constituted such that they cannot be separated.

The present invention is not limited by the above-described example but is capable of various changes and deformations.

Also, the power converter described by using this embodiment can realize cost reduction through size and weight reduction and a large amount of power supply by enabling incorporation in any one of an electric vehicle, a robot, a home electric appliance, a solar generator, a motor and generator, a large-capacity power source, medical equipment, a liquid-crystal TV, and an LED illumination power source. As a result, the present invention contributes to reduction of CO2 as compared with the prior-art methods.

As described above, the power converter of the present invention is to boost an output voltage of a DC power supply and is constituted by the two transducers whose respective primary windings are connected to the positive electrode of a positive power supply of the DC power supply, the two switching elements connected between the respective primary windings of the transducers and the negative electrode of the DC power supply, the inductor portion connected between the secondary winding of the first transducer and the secondary winding of the second transducer, and the two serial circuits connected between the respective primary windings of the two transducers and the negative electrode of the DC power supply and including the diode and the capacitor, in which the secondary windings of the two transducers and the inductor portion are connected in series to each other so as to form a closed loop, the respective capacitors included in the two serial circuits share the single smoothing capacitor, and the core is composed of the two outer legs around which the primary windings of the two transducers are wound, respectively, and the center leg.

Also, the power converter of the present invention is to boost the output voltage of the DC power supply and has the complex magnetic circuit composed of the core forming the closed magnetic path, the two winding wires wound around the outer legs of the core, respectively, one ends of which are connected to the positive electrode of the DC power supply, while the other ends are connected to the negative electrode of the DC power supply via the switching element, respectively, the two serial circuits connected between the respective other ends of the two winding wires and the negative electrode of the DC power supply and including the diode and the smoothing capacitor, and the control circuit that prepares and turns on/off the two switching elements with a phase difference of a ½ cycle.

The power converter of the present invention was described by using the DC/DC converter as an example, but it may be an inverter circuit device or moreover, it may be any one of an electric vehicle, a robot, a home electric appliance, a solar generator, a motor and generator, a large-capacity power source, medical equipment, a liquid-crystal TV, and an LED illumination power source provided with the inverter circuit.

Also, the power converter of the present invention may be an IC circuit by interleave control. As described above, according to the power converter of the present invention, since the core is a closed magnetic path composed of a center leg, a first cylindrical outer leg arranged in parallel with the center leg and around which a winding wire is wound, and a second outer leg arranged at a position opposite to the first outer leg with respect to the center leg, when the winding wire is to be wound, the bonding degree between the core and the winding wire is high, whereby power loss can be decreased, and size can be reduced.

### EXPLANATION OF REFERENCE NUMERALS

Vdc1 DC power supply
T1, T2 transducer
Q1, Q2 switching element
L reactor
C smoothing capacitor
RL load
10 control circuit
40 magnetic circuit
41 core
42, 43 outer leg
45 center leg
46 air gap
50, 51 magnetic body
55 space
60, 61 winding wire

1. A power converter comprising a core formed by a magnetic material and a winding wire wound around a predetermined position of the core and operating in a two-phase mode, characterized in that:
said core is a closed magnetic path constituted by:
a center leg;
a first cylindrical outer leg arranged in parallel with the center leg and around which the winding wire is wound; and
a second outer leg arranged at a position opposite to said first outer leg with respect to said center leg.

2. The power converter according to claim 1, wherein said center leg has a cylindrical shape.

3. The power converter according to claim 1, wherein said core can be separated.

4. The power converter according to claim 1, wherein said power converter boosts an output voltage of a DC power supply and is composed of;
two transducers whose respective primary windings are connected to a positive electrode of a positive power supply of said DC power supply;
two switching elements connected between the respective primary windings of the transducers and a negative electrode of the DC power supply;
an inductor portion connected between secondary winding of the first transducer and secondary winding of the second transducer; and
two serial circuits connected between the respective primary windings of said two transducers and the negative electrode of said DC power supply, respectively, and including a diode and a capacitor, wherein
the secondary windings of said two transducers and said inductor portion are connected in series to each other so as to form a closed loop;
the respective capacitors included in said two serial circuits share one smoothing capacitor; and
said core is composed of two outer legs around which the primary windings of said two transducers are wound, respectively, and said center leg.

5. The power converter according to claim 1, wherein the entire shape of said core is a rounded shape.

6. The power converter according to claim 1, wherein said power converter is a DC/DC converter.

7. The power converter according to claim 1, wherein said power converter is an inverter circuit device.

8. The power converter according to claim 7, wherein
said power converter is mounted on any one of an electric vehicle, a robot, a home electric appliance, a solar generator, a motor and generator, a large-capacity power source, medical equipment, a liquid-crystal TV, and an LED illumination power source.
